(19) United States
(12) Patent Application Publication
(10) Pub. No.: US 2024/0292314 A1
(43) Pub. Date: Aug. 29, 2024

(54) METHOD AND APPARATUS FOR ROUTING PATH SWITCHING IN WIRELESS COMMUNICATION SYSTEM

(71) Applicant: LG Electronics Inc., Seoul (KR)

(72) Inventors: Sunghoon JUNG, Seoul (KR); Hyunjung CHOE, Seoul (KR); Oanyong LEE, Seoul (KR)

(21) Appl. No.: 18/570,537

(22) PCT Filed: Aug. 1, 2022
(86) PCT No.: PCT/KR2022/011281

§ 371 Date: Dec. 14, 2023

(30) Foreign Application Priority Data
Jul. 30, 2021 (KR) 10-2021-0100847

(51) Int. Cl. H04W 40/34; H04L 45/00; H04W 36/30; H04W 76/19

(52) U.S. Cl. CPC H04W 40/34; H04L 45/22; H04W 36/305; H04W 76/19

(57) ABSTRACT

The present disclosure related to a routing path switching in wireless communications. According to an embodiment of the present disclosure, a parent node in an integrated access and backhaul (IAB) system may provide an indication of triggered local routing to child node(s). Therefore, based on the indication, the child node can determine whether to perform a local re-routing, and determine for which traffic flow the child node had better perform a local re-routing.

### TECHNICAL FIELD

The present disclosure related to a routing path switching in wireless communications.

### BACKGROUND ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In wireless communications, an integrated access and backhaul (IAB) node may transmit packets related to a traffic flow to a parent node/child node via a routing path. When the routing path needs to be changed, the IAB node may perform a routing path switching, and transmit packets via the switched routing path. The routing path switching may also be referred to as local re-routing.

### DISCLOSURE OF INVENTION

### Technical Problem

An aspect of the present disclosure is to provide method and apparatus for routing path switching in a wireless communication system.

### Solution to Problem

According to an embodiment of the present disclosure, a method performed by a first wireless device in a wireless communication system comprises: connecting to a second wireless device; performing a transmission related to one or more data flows to the second wireless device; detecting a problem of a backhaul connection between the first wireless device and the second wireless device; and transmitting, to a fourth wireless device, a backhaul adaptation protocol (BAP) protocol data unit (PDU) comprising a re-routing notification informing whether the first wireless device switches a routing path for at least one of the one or more data flows from the second wireless device to a third wireless device upon detecting the problem.

According to an embodiment of the present disclosure, a method performed by a fourth wireless device in a wireless communication system comprises: connecting to a first wireless device; performing a transmission related to one or more data flows to the first wireless device; receiving, from the first wireless device, a backhaul adaptation protocol (BAP) protocol data unit (PDU) comprising a re-routing notification informing whether the first wireless device switches a routing path for at least one of the one or more data flows from a second wireless device to a third wireless device upon detecting a problem of a backhaul connection between the first wireless device and the second wireless device; performing a transmission related to one or more first data flows to the first wireless device based on the re-routing notification informing that the first wireless device switches a routing path for the one or more first data flows; and switching a routing path for one or more second data flows from the first wireless device to a fifth wireless device based on the re-routing notification informing that the first wireless device does not switch the routing path for the one or more second data flows.

According to an embodiment of the present disclosure, a first wireless device configured to operate in a wireless communication system comprises: at least one transceiver; at least processor; and at least one computer memory operably connectable to the at least one processor and storing instructions that, based on being executed by the at least one processor, perform operations comprising: connecting to a second wireless device; performing a transmission related to one or more data flows to the second wireless device; detecting a problem of a backhaul connection between the first wireless device and the second wireless device; and transmitting, to a fourth wireless device, a backhaul adaptation protocol (BAP) protocol data unit (PDU) comprising a re-routing notification informing whether the first wireless device switches a routing path for at least one of the one or more data flows from the second wireless device to a third wireless device upon detecting the problem.

According to an embodiment of the present disclosure, a fourth wireless device configured to operate in a wireless communication system comprises: at least one transceiver; at least processor; and at least one computer memory operably connectable to the at least one processor and storing instructions that, based on being executed by the at least one processor, perform operations comprising: connecting to a first wireless device; performing a transmission related to one or more data flows to the first wireless device; receiving, from the first wireless device, a backhaul adaptation protocol (BAP) protocol data unit (PDU) comprising a re-routing notification informing whether the first wireless device switches a routing path for at least one of the one or more data flows from a second wireless device to a third wireless device upon detecting a problem of a backhaul connection between the first wireless device and the second wireless device; performing a transmission related to one or more first data flows to the first wireless device based on the re-routing notification informing that the first wireless device switches a routing path for the one or more first data flows; and switching a routing path for one or more second data flows from the first wireless device to a fifth wireless device based on the re-routing notification informing that the first wireless device does not switch the routing path for the one or more second data flows.

According to an embodiment of the present disclosure, at least one computer readable medium (CRM) stores instructions that, based on being executed by at least one processor, perform operations comprising: connecting to a second wireless device; performing a transmission related to one or more data flows to the second wireless device; detecting a problem of a backhaul connection between the first wireless device and the second wireless device; and transmitting, to a fourth wireless device, a backhaul adaptation protocol (BAP) protocol data unit (PDU) comprising a re-routing notification informing whether the first wireless device switches a routing path for at least one of the one or more data flows from the second wireless device to a third wireless device upon detecting the problem.

According to an embodiment of the present disclosure, an apparatus configured to operate in a wireless communication system comprises: at least processor; and at least one computer memory operably connectable to the at least one processor, wherein the at least one processor is configured to perform operations comprising: connecting to a second wireless device; performing a transmission related to one or more data flows to the second wireless device; detecting a problem of a backhaul connection between the first wireless device and the second wireless device; and transmitting, to a fourth wireless device, a backhaul adaptation protocol (BAP) protocol data unit (PDU) comprising a re-routing notification informing whether the first wireless device switches a routing path for at least one of the one or more data flows from the second wireless device to a third wireless device upon detecting the problem.

### Advantageous Effects of Invention

The present disclosure can have various advantageous effects.

For example, child node notified of a backhaul problem from a parent node can identify for which traffic flow the parent node has performed a local re-routing. Based on the notification, the child node can determine whether to perform a local re-routing, and determine for which traffic flow the child node had better perform a local re-routing. Therefore, unnecessary re-routing by the child node can be prevented.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIG. 6 shows a frame structure in a 3GPP based wireless communication system to which implementations of the present disclosure is applied.

FIG. 7 shows an example of IAB topology to which technical features of the present disclosure can be applied.

FIG. 8 shows a parent and child node relationship for IAB node to which technical features of the present disclosure can be applied.

FIG. 9 shows an example of a protocol stack for F1-U protocol between IAB-DU and IAB donor-CU to which technical features of the present disclosure can be applied.

FIG. 10 shows an example of a protocol stack for F1-C protocol between IAB-DU and IAB donor-CU to which technical features of the present disclosure can be applied.

FIG. 11 shows an example of a protocol stack for IAB-MT's RRC and NAS connections.

FIG. 12 shows an example of routing and BH RLC channel selection on BAP sublayer to which technical features of the present disclosure can be applied.

FIG. 13 shows an example of a functional view of BAP sublayer to which technical features of the present disclosure can be applied.

FIG. 14 shows an example of a method performed by a node transmitting a re-routing notification according to an embodiment of the present disclosure.

FIG. 15 shows an example of a method performed by a node receiving a re-routing notification according to an embodiment of the present disclosure.

FIG. 16 shows an example of a scenario in which re-routing notification is transmitted according to an embodiment of the present disclosure.

FIG. 17 shows an example of a scenario in which re-routing notification is not transmitted according to an embodiment of the present disclosure.

FIG. 18 shows an example of a scenario in which re-routing notification for specific traffic flow(s) is transmitted according to an embodiment of the present disclosure.

### MODE FOR THE INVENTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Throughout the disclosure, the terms ‘radio access network (RAN) node’, ‘base station’, ‘eNB’, ‘gNB’ and ‘cell’ may be used interchangeably. Further, a UE may be a kind of a wireless device, and throughout the disclosure, the terms ‘UE’ and ‘wireless device’ may be used interchangeably.

Throughout the disclosure, the terms ‘cell quality’, ‘signal strength’, ‘signal quality’, ‘channel state’, ‘channel quality’. ‘channel state/reference signal received power (RSRP)’ and ‘reference signal received quality (RSRQ)’ may be used interchangeably.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

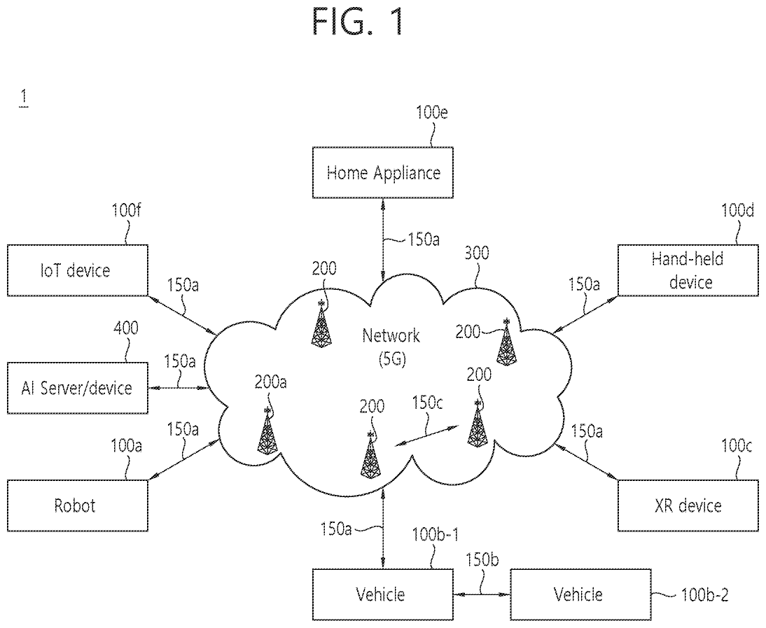

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

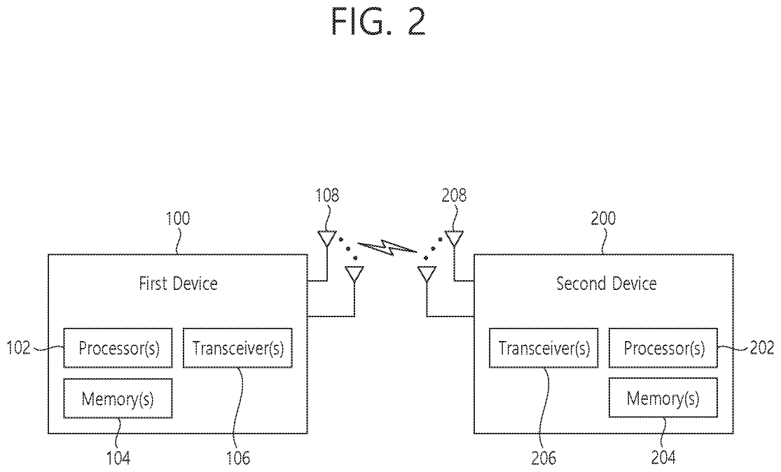

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 20 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

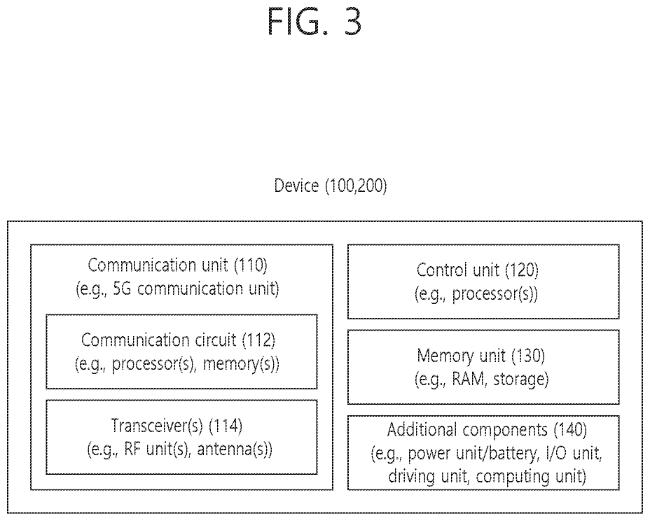

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

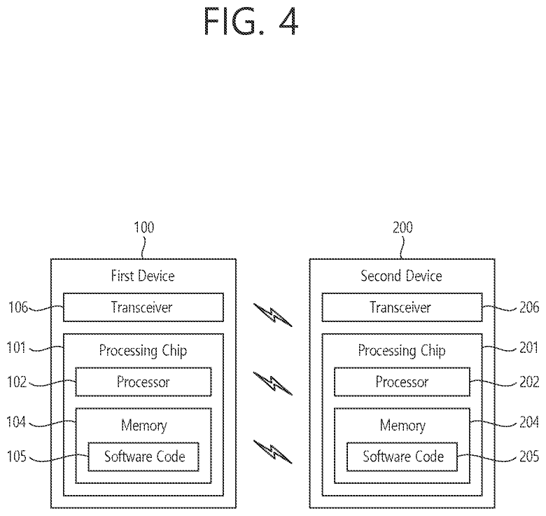

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

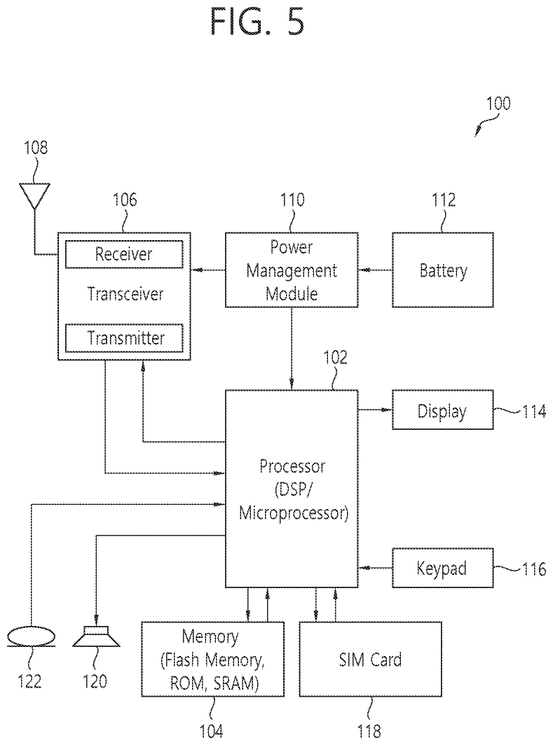

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

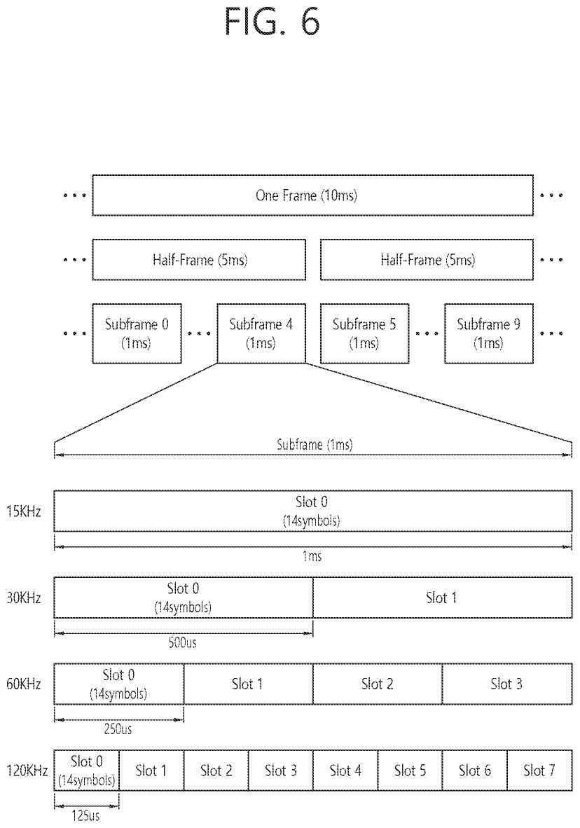

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP},i−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times. In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

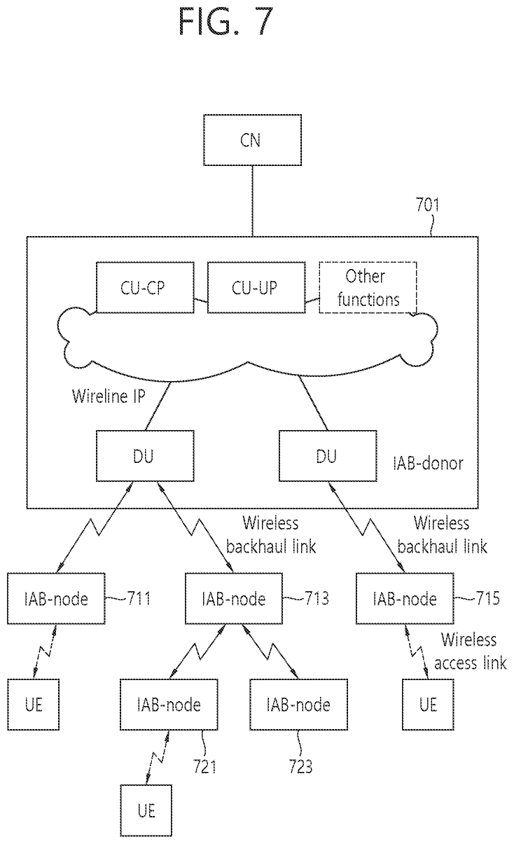

FIG. 7 shows an example of IAB topology to which technical features of the present disclosure can be applied.

Referring to FIG. 7, the IAB topology may comprise an IAB donor 701 and multiple IAB nodes 711, 713, 715, 721 and 723. “IAB donor node (or, simply IAB donor)” refers to a RAN node which provides UE's interface to core network (CN) and wireless backhauling functionalities to IAB nodes. The IAB donor 701 may be treated as a signal logical node that may comprise a set of functions such as one or more distributed units (DUs), a central unit (CU) and/or potentially other functions.

The CU may be functionally split into a CU-control plane (CU-CP) and at least one CU-user plane (CU-UP).

The CU-CP may be a logical node hosting an RRC and a control plane part of a PDCP protocol of the CU for a gNB. As illustrated, the CU-CP is connected to the DU through F1-C interface. The CU-CP terminates an E1 interface connected with the CU-UP and the F1-C interface connected with the DU.

The CU-UP may be a logical node hosting a user plane part of the PDCP protocol of the CU for a gNB, and the user plane part of the PDCP protocol and a SDAP protocol of the CU for a gNB. As illustrated, the CU-UP is connected to the DU through F1-U interface, and is connected to the CU-CP through the E1 interface. The CU-UP terminates the E1 interface connected with the CU-CP and the F1-U interface connected with the DU.

In CU CP-UP split structure, the following properties may hold:
(1) A DU may be connected to a CU-CP.
(2) A CU-UP may be connected to a CU-CP.
(3) A DU can be connected to multiple CU-UPs under the control of the same CU-CP (i.e., the CU-CP to which the DU is connected and the multiple CU-UPs are connected).
(4) A CU-UP can be connected to multiple DUs under the control of the same CU-CP (i.e., the CU-CP to which the CU-UP is connected and the multiple DUs are connected).

According to various embodiments, each IAB node may comprise a set of functions including one or more distributed units (DUs), a central unit (CU) and/or potentially other functions, as well as the IAB donor.

In a deployment, the IAB donor can be split according to these functions, which can all be either collocated or non-collocated. Also, some of the functions presently associated with the IAB donor may eventually be moved outside of the IAB donor in case it becomes evident that the functions do not perform IAB-specific tasks.

The IAB donor 701 may be connected to the IAB node 711, 713 and 715 via wireless backhaul link (hereinafter, the terms “wireless backhaul link” and “wireless backhaul channel” can be used interchangeably), and may communicate with the IAB node 711, 713 and/or 715 via the wireless backhaul link. For example, DUs of the IAB donor 701 may be used to communicate with the IAB nodes 711, 713 and/or 715 via wireless backhaul link. Each of the IAB node 711 and 715 may communicate with a UE served by itself via wireless access link (hereinafter, the term “wireless access link and wireless access channel can be used interchangeably). Further, the IAB donor 701 may be a parent node for the IAB node 711, 713 and 715, and the IAB node 711, 713 and 715 may be a child node for the IAB donor 701. The definition of the parent node and the child node will be described later.

The IAB node 713 may be connected to IAB node 721 and 723 via wireless backhaul link, and may communicate with the IAB node 721 and/or 723 via wireless backhaul link. The IAB node 721 may communicate with a UE served by itself via wireless access link. Further, the IAB node 713 may be a parent node for the IAB node 721 and 723, and the IAB node 721 and 723 may be a child node for the IAB node 713.

The IAB nodes 711, 713 and 715 may directly communicate with IAB donor 701 via wireless backhaul link. Therefore, the distance between the IAB donor 701 and each of the TAB nodes 711, 713 and 715 may be expressed as 1-hop distance. The IAB donor 701 may be 1-hop parent node for the IAB nodes 711, 713 and 715, and the IAB nodes 711, 713 and 715 may be 1-hop child node for the IAB donor 701.

The IAB nodes 721 and 723 may communicate with the IAB donor 701 via a first wireless backhaul link and a second wireless backhaul link. The first wireless backhaul link may be a wireless backhaul link between i) the IAB node 713 ii) the IAB nodes 721 and/or 723. The second wireless backhaul link may be a wireless backhaul link between the IAB node 713 and the IAB donor 701. Therefore, the distance between the IAB donor 701 and each of the IAB nodes 721 and 723 may be expressed as 2-hop distance. The IAB donor 701 may be 2-hop parent node for the IAB nodes 721 and 723, and the IAB nodes 721 and 723 may be 2-hop child node for the IAB donor 701. In a similar way. N-hop distance may be defined between arbitrary IAB nodes (including or not including IAB donor), and thus, N-hop parent node and N-hop child node may also be defined.

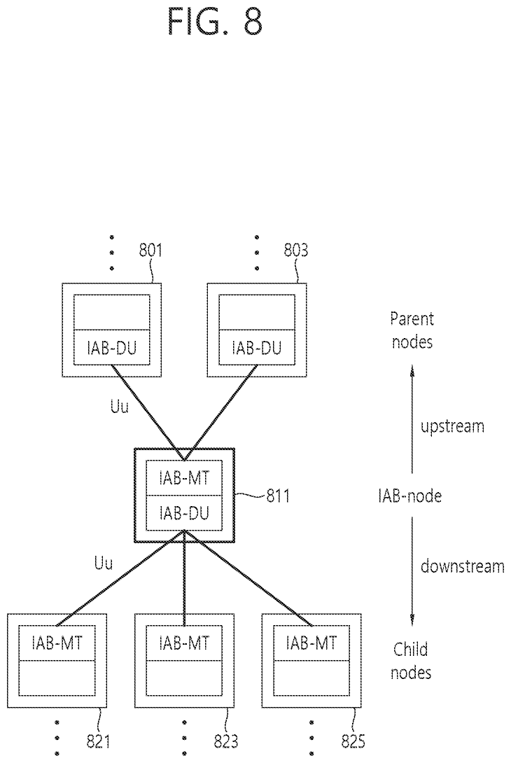

FIG. 8 shows a parent and child node relationship for IAB node to which technical features of the present disclosure can be applied.

Referring to FIG. 8, an IAB node 811 may be connected to parent nodes 801 and 803 via wireless backhaul links, and may be connected to child nodes 821, 823 and 825 via wireless backhaul links. Throughout the disclosure, “parent IAB node (or, simply parent node)” for an JAB node may be defined as a next hop neighbor node with respect to an IAB-mobile termination (IAB-MT, or simply MT) of the IAB node. That is, the neighbor node on the IAB-MT's interface may be referred to as a parent node. The parent node can be IAB node or IAB donor-DU. Further, “child IAB node (or, simply child node)” for an IAB node may be defined as a next hop neighbor node with respect to an IAB-DU (or, simply DU) of the IAB node. That is, the neighbor node on the IAB-DU's interface may be referred to as a child node.

IAB-MT may refer to an IAB node function that terminates the Uu interface to the parent node. IAB-DU may refer to a gNB-DU functionality supported by the IAB node to terminate the access interface to UEs and next-hop IAB nodes, and/or to terminate the F1 protocol to the gNB-CU functionality on the IAB donor.

The direction toward the child node may be referred to as downstream while the direction toward the parent node may be referred to as upstream. Further, a backhaul link between an IAB node and a parent node for the IAB node may be referred to as upward backhaul link for the IAB node. A backhaul link between an IAB node and a child node for the IAB node may be referred to as downward backhaul link for the IAB node. A backhaul link for an IAB node may comprise at least one of an upward backhaul link for the IAB node, or a downward backhaul link for the IAB node.

The IAB-node may have redundant routes to the IAB-donor CU.

For IAB-nodes operating in SA-mode. NR dual connectivity (DC) may be used to enable route redundancy in the backhaul (BH) by allowing the IAB-MT to have concurrent BH RLC links with two parent nodes. That is, an IAB node may establish a connection with a parent node which may be a master node (MN) and another parent node which may be a secondary node (SN), and utilize radio resources provided by the two parent nodes.

The parent nodes have to be connected to the same IAB-donor CU-CP, which controls the establishment and release of redundant routes via these two parent nodes. The parent nodes together with the IAB-donor CU may obtain the roles of the IAB-MTs master node and secondary node. The NR DC framework (e.g. MCG/SCG-related procedures) may be used to configure the dual radio links with the parent nodes.

An IAB node may perform a radio link monitoring (RLM) for detecting a problem on a backhaul connection established between the IAB node and a parent node for the IAB node. The IAB node may detect a radio link failure (RLF) on the backhaul connection towards the parent node based on detecting the problem.

To detect the problem on the backhaul connection towards the parent node, the IAB node shall:
1> if any DAPS bearer is configured, upon receiving N310 consecutive “out-of-sync” indications for the source SpCell from lower layers while T304 is running:
2> start timer T310 for the sourceSpCell.
1> upon receiving N310 consecutive “out-of-sync” indications for the SpCell from lower layers while neither T300, T301, T304, T311, T316 nor T319 are running:
2> start timer T310 for the corresponding SpCell.

Upon receiving N311 consecutive “in-sync” indications for the SpCell from lower layers while T310 is running, the IAB node shall:
1> stop timer T310 for the corresponding SpCell, and determine that the physical layer problems are recovered.
1> stop timer T312 for the corresponding SpCell, if running, and determine that the physical layer problems are recovered.

In this case, the IAB node maintains the backhaul connection without explicit signalling, i.e., the IAB node maintains the entire radio resource configuration.

Periods in time where neither “in-sync” nor “out-of-sync” is reported by L1 (i.e., physical layer) do not affect the evaluation of the number of consecutive “in-sync” or “out-of-sync” indications.

To detect an RLF, the IAB node shall:
1> upon T310 expiry in PCell; or
1> upon T312 expiry in PCell; or
1> upon random access problem indication from MCG MAC while neither T300, T301, T304, T311 nor T319 are running; or
1> upon indication from MCG RLC that the maximum number of retransmissions has been reached, or
1> if connected as an IAB-node, upon BH RLF indication received on BAP entity from the MCG; or
1> upon consistent uplink LBT failure indication from MCG MAC while T304 is not running:
2> if the indication is from MCG RLC and CA duplication is configured and activated, and for the corresponding logical channel allowedServingCells only includes SCell(s):
3> initiate the failure information procedure to report RLC failure.
2> else:
3> consider radio link failure to be detected for the MCG i.e. RLF;

For example, an IAB node may detect an RLF on a backhaul connection towards a parent node based on a number of consecutive out-of-sync events detected on the backhaul connection reaching an RLF threshold during a pre-defined or configured time period.

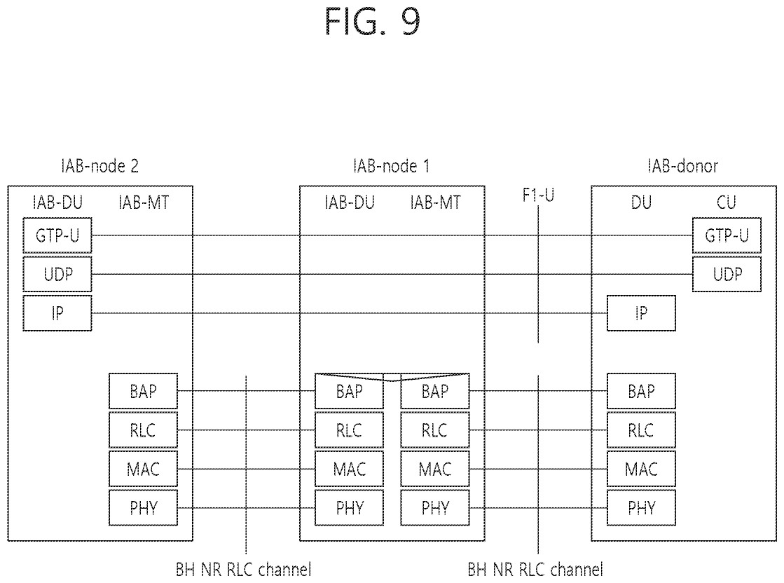

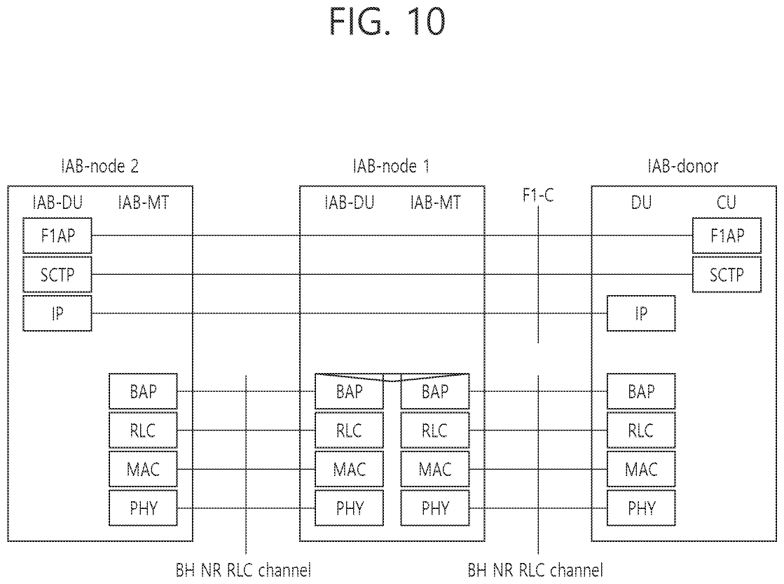

FIG. 9 shows an example of a protocol stack for F1-U protocol between IAB-DU and IAB donor-CU to which technical features of the present disclosure can be applied. FIG. 10 shows an example of a protocol stack for F1-C protocol between IAB-DU and IAB donor-CU to which technical features of the present disclosure can be applied. In FIGS. 9-10, it is exemplary assumed that F1-U and F1-C are carried over 2 backhaul hops.

Referring to FIGS. 9 to 10, on the wireless backhaul, the IP layer may be carried over a backhaul adaptation protocol (BAP) sublayer, which enables routing over multiple hops. The IP layer may be also used for some non-F1 traffic, such as signalling traffic for the establishment and management of SCTP associations and the F1-supporting security layer.

On each backhaul link, the BAP PDUs may be carried by backhaul (BH) radio link control (RLC) channels. Multiple BH RLC channels can be configured on each BH link to allow traffic prioritization and QoS enforcement. The BH-RLC-channel mapping for BAP PDUs may be performed by the BAP entity on each IAB-node and the IAB-donor.

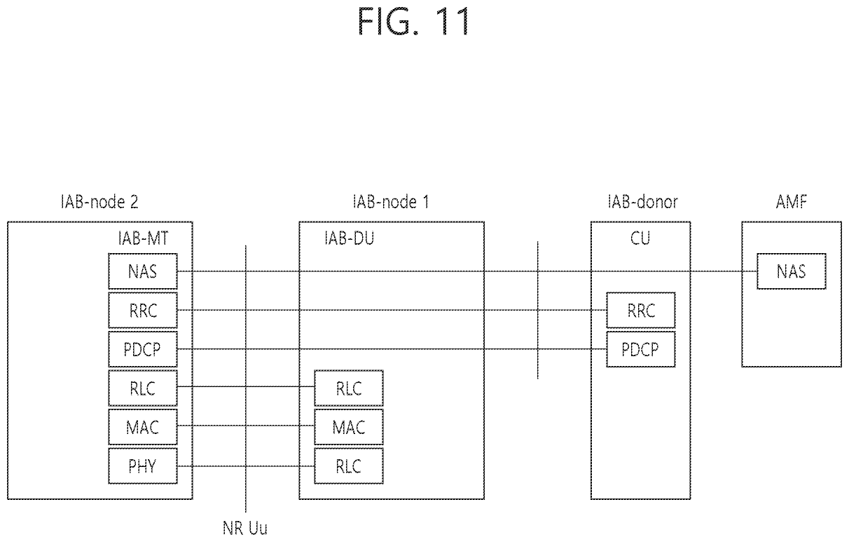

FIG. 11 shows an example of a protocol stack for IAB-MTs RRC and NAS connections.

Referring to FIG. 11, protocol stacks for SRB and/or DRB are shown. The TAB-MT may establish SRBs carrying RRC and NAS and potentially DRBs (e.g. carrying OAM traffic) with the IAB-donor. These SRBs and DRBs may be transported between the IAB-MT of an IAB node and a parent node for the IAB node over Uu access channel(s).

In FIGS. 7 to 9, each of the IAB donor, IAB node 1 and IAB node 2 may comprise a physical (PHY) layer, a media access control (MAC) layer, a radio link control (RLC) layer, a packet data convergence protocol (PDCP) layer, a radio resource control (RRC) layer and/or a non-access stratum (NAS) layer.

The PHY layer may belong to layer 1 (L1). The PHY layer offers information transfer services to MAC sublayer and higher layers. The PHY layer offers to the MAC sublayer transport channels. Data between the MAC sublayer and the PHY layer is transferred via the transport channels. Between different PHY layers. i.e., between a PHY layer of a transmission side and a PHY layer of a reception side, data is transferred via the physical channels.

The MAC sublayer may belong to layer 2 (L2). The main services and functions of the MAC sublayer include mapping between logical channels and transport channels, multiplexing/de-multiplexing of MAC service data units (SDUs) belonging to one or different logical channels into/from transport blocks (TB) delivered to/from the physical layer on transport channels, scheduling information reporting, error correction through hybrid automatic repeat request (HARQ), priority handling between UEs by means of dynamic scheduling, priority handling between logical channels of one UE by means of logical channel prioritization (LCP), etc. The MAC sublayer offers to the radio link control (RLC) sublayer logical channels.

The RLC sublayer belong to L2. The RLC sublayer supports three transmission modes, i.e. transparent mode (TM), unacknowledged mode (UM), and acknowledged mode (AM), in order to guarantee various quality of services (QoS) required by radio bearers. The main services and functions of the RLC sublayer depend on the transmission mode. For example, the RLC sublayer provides transfer of upper layer PDUs for all three modes, but provides error correction through ARQ for AM only. In LTE/LTE-A, the RLC sublayer provides concatenation, segmentation and reassembly of RLC SDUs (only for UM and AM data transfer) and re-segmentation of RLC data PDUs (only for AM data transfer). In NR, the RLC sublayer provides segmentation (only for AM and UM) and re-segmentation (only for AM) of RLC SDUs and reassembly of SDU (only for AM and UM). That is, the NR does not support concatenation of RLC SDUs. The RLC sublayer offers to the packet data convergence protocol (PDCP) sublayer RLC channels.

The PDCP sublayer belong to L2. The main services and functions of the PDCP sublayer for the user plane include header compression and decompression, transfer of user data, duplicate detection, PDCP PDU routing, retransmission of PDCP SDUs, ciphering and deciphering, etc. The main services and functions of the PDCP sublayer for the control plane include ciphering and integrity protection, transfer of control plane data, etc.

A radio resource control (RRC) layer belongs to L3. The RRC layer is only defined in the control plane. The RRC layer controls radio resources between the UE and the network. To this end, the RRC layer exchanges RRC messages between the UE and the BS. The main services and functions of the RRC layer include broadcast of system information related to AS and NAS, paging, establishment, maintenance and release of an RRC connection between the UE and the network, security functions including key management, establishment, configuration, maintenance and release of radio bearers, mobility functions. QoS management functions, UE measurement reporting and control of the reporting, NAS message transfer to/from NAS from/to UE.

In other words, the RRC layer controls logical channels, transport channels, and physical channels in relation to the configuration, reconfiguration, and release of radio bearers. A radio bearer refers to a logical path provided by L1 (PHY layer) and L2 (MAC/RLC/PDCP/SDAP sublayer) for data transmission between a UE and a network. Setting the radio bearer means defining the characteristics of the radio protocol layer and the channel for providing a specific service, and setting each specific parameter and operation method. Radio bearer may be divided into signaling RB (SRB) and data RB (DRB). The SRB is used as a path for transmitting RRC messages in the control plane, and the DRB is used as a path for transmitting user data in the user plane.

An RRC state indicates whether an RRC layer of the UE is logically connected to an RRC layer of the E-UTRAN. In LTE/LTE-A, when the RRC connection is established between the RRC layer of the UE and the RRC layer of the E-UTRAN, the UE is in the RRC connected state (RRC_CONNECTED). Otherwise, the UE is in the RRC idle state (RRC_IDLE). In NR, the RRC inactive state (RRC_INACTIVE) is additionally introduced. RRC_INACTIVE may be used for various purposes. For example, the massive machine type communications (MMTC) UEs can be efficiently managed in RRC_INACTIVE. When a specific condition is satisfied, transition is made from one of the above three states to the other.

A predetermined operation may be performed according to the RRC state. In RRC_IDLE, public land mobile network (PLMN) selection, broadcast of system information (SI), cell re-selection mobility, core network (CN) paging and discontinuous reception (DRX) configured by NAS may be performed. The UE shall have been allocated an identifier (ID) which uniquely identifies the UE in a tracking area. No RRC context stored in the BS.

In RRC_CONNECTED, the UE has an RRC connection with the network (i.e. E-UTRAN/NG-RAN). Network-CN connection (both C/U-planes) is also established for UE. The UE AS context is stored in the network and the UE. The RAN knows the cell which the UE belongs to. The network can transmit and/or receive data to/from UE. Network controlled mobility including measurement is also performed.

Most of operations performed in RRC_IDLE may be performed in RRC_INACTIVE. But, instead of CN paging in RRC_IDLE, RAN paging is performed in RRC_INACTIVE. In other words, in RRC_IDLE, paging for mobile terminated (MT) data is initiated by core network and paging area is managed by core network. In RRC_INACTIVE, paging is initiated by NG-RAN, and RAN-based notification area (RNA) is managed by NG-RAN. Further, instead of DRX for CN paging configured by NAS in RRC_IDLE, DRX for RAN paging is configured by NG-RAN in RRC_INACTIVE. Meanwhile, in RRC_INACTIVE, 5GC-NG-RAN connection (both C/U-planes) is established for UE, and the UE AS context is stored in NG-RAN and the UE. NG-RAN knows the RNA which the UE belongs to.

NAS layer is located at the top of the RRC layer. The NAS control protocol performs the functions, such as authentication, mobility management, security control.

Further, each of the IAB donor, IAB node 1 and IAB node 2 may comprise a BAP layer/sublayer. The main service and functions of the BAP sublayer may include:
Transfer of data:
Routing of packets to next hop;
Determination of BAP destination and path for packets from upper layers;
Determination of egress RLC channels for packets routed to next hop;
Differentiating traffic to be delivered to upper layers from traffic to be delivered to egress link;
Flow control feedback signalling; and/or
BH RLF notification.

The IAB-DU's IP traffic may be routed over the wireless backhaul via the BAP sublayer. In downstream direction, IP packets may be encapsulated by the BAP sublayer at the IAB-donor, and de-encapsulated at the destination IAB-node. In upstream direction, the upper layer traffic may be encapsulated at the IAB-node, and de-encapsulated at the IAB-donor.

On the BAP sublayer, packets may be routed based on the BAP routing ID, which is carried in the BAP header. The BAP header may be added to the packet when the packet arrives from upper layers, and the packet may be stripped off when the packet has reached a destination node of the packet. The selection of the packet's BAP routing ID may be configured by the IAB-donor. The BAP routing ID may comprise/consists of BAP address (e.g., destination Id for a destination node) and BAP path ID related to a routing path. The BAP address may indicate the destination node of the packet on the BAP sublayer, and the BAP path ID may indicate the routing path the packet should follow to the destination. For the purpose of routing, each IAB-node may be further configured with a designated BAP address.

On each hop of the packet's path, the IAB-node may inspect the packet's BAP address in the routing header to determine if the packet has reached its destination, i.e., matches the IAB-node's BAP address. In case the packet has not reached the destination, the IAB-node may determine the next hop backhaul link, referred to as egress link, based on the BAP routing ID carried in the packet header and a routing configuration the IAB-node received from the TAB-donor.

The IAB-node may also select the BH RLC channel on the designated egress link. For packets arriving from upper layers, the selection of the BH RLC channel may be configured by the CU, and it is based on upper layer traffic specifiers. Since each BH RLC channel is configured with a QoS code point or priority level, RLC-channel selection may facilitate traffic-specific prioritization and QoS enforcement on the BH. For F1-U traffic, it may be possible to map each GTP-U tunnel to a dedicated BH RLC channel or to aggregate multiple GTP-U tunnels into one common BH RLC channel.

When packets are routed from one BH link to another, the BH RLC channel on the egress BH link may be determined based on the mapping configuration between ingress BH RLC channels and egress BH RLC channels provided by the IAB-donor.

In upstream direction, the IAB-donor CU may configure the IAB-node with mappings between upstream F1- and non-F1-traffic originated at the IAB-node, and the appropriate BAP routing ID and Backhaul RLC channel. A specific mapping may be configured:
for each F1-U GTP-U tunnel;
for non-UE associated F1 AP messages:
for UE-associated F1AP messages of each UE; and/or
for non-F1 traffic.

Multiple mappings can contain the same Backhaul RLC channel and/or BAP routing ID.

These configurations may be received via F1AP. During IAB-node integration, before F1AP is established, a default BH RLC channel and a default BAP routing ID may be configured via RRC, which are used for all upper layer traffic.

In downstream direction, traffic mapping may occur internal to the IAB-donor.

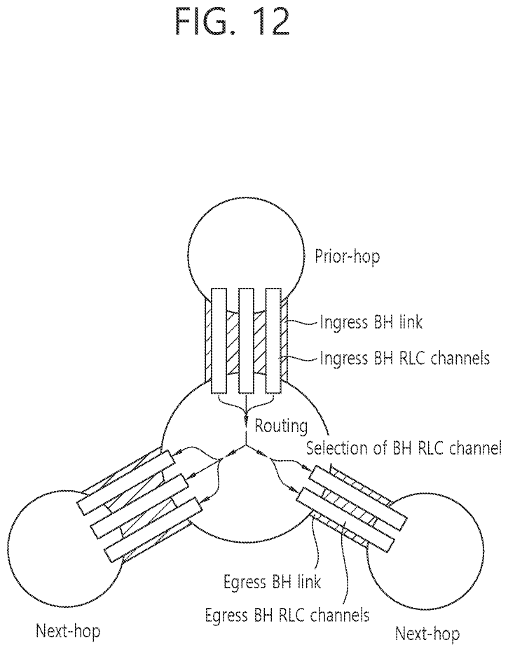

FIG. 12 shows an example of routing and BH RLC channel selection on BAP sublayer to which technical features of the present disclosure can be applied.

Routing on BAP sublayer may use the BAP routing ID, which is configured by the IAB-donor. For the routing ID, the flow control information may be provided in the flow control feedback. The BAP routing ID may comprise/consist of BAP address and BAP path ID. A length of the routing ID may be 20 bits, in which leftmost 10 bits may indicate BAP address and rightmost 10 bits may indicate BAP path ID. The BAP address may be used for the following purposes:
1. Determination if a packet has reached the destination node, i.e. IAB-node or IAB-donor DU, on BAP sublayer. This may be the case if the BAP address in the packet's BAP header matches the BAP address configured via RRC on the IAB-node, or via F1AP on the IAB-donor DU.
2. Determination of the next-hop node for packets that have not reached their destination. This may apply to packets arriving from a prior hop on BAP sub-layer or that have been received from IP layer.

For packets arriving from a prior hop, the determination of the next-hop node may be based on a routing configuration provided by the IAB-donor CU via F1AP signalling. The routing configuration may contain the mapping between the BAP routing ID carried in the packet's BAP header and the next-hop node's BAP address, as specified in table 5:

TABLE 5

| BAP routing ID | Next-hop BAP address |
|---|---|
| Derived from BAP packet's | To be used to forward |
| BAP header | packet |

The IAB-node may resolve the next-hop BAP address to a physical backhaul link. For this purpose, IAB-donor CU may provide IAB-node with its child-node's BAP address in a UE-associated F1AP message and its parent-node's BAP address in RRC signalling. The IAB-node can receive multiple routing configurations with the same destination BAP address but different BAP path IDs. These routing configurations may resolve to the same or different egress BH links. In case the BH link has RLF, the IAB-node may select another BH link based on routing entries with the same destination BAP address, i.e., by disregarding the BAP path ID. In this manner, a packet can be delivered via an alternative path in case the indicated path is not available.

When routing a packet from an ingress to an egress BH link, the IAB-node may derive the egress RLC-channel on the egress BH link through an F1AP-configured mapping from the RLC channel used on the ingress BH link. The RLC channel IDs used for ingress and egress BH RLC channels may be generated by the IAB-donor CU. Since the RLC channel ID only has link-local scope, the mapping configurations may also include the BAP addresses of prior and next hop, as specified in table 6:

TABLE 6

| Next-hop | Prior-hop | Ingress RLC | Egress RLC |
|---|---|---|---|
| BAP address | BAP address | channel ID | channel ID |
| Derived | Derived | Derived | To be used |
| from routing | from packet's | from packet's | on egress link to |
| configuration | ingress link | ingress link | forward packet |

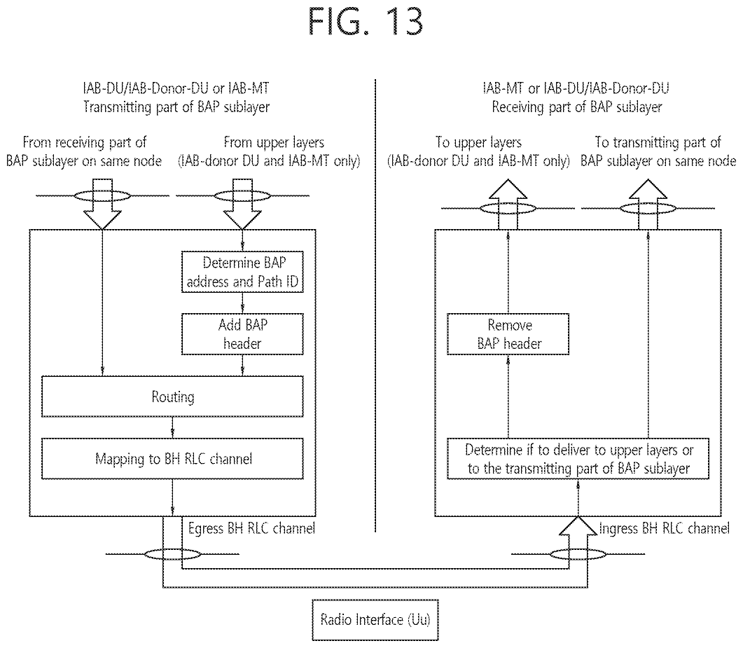

The IAB-node may resolve the BH RLC channel IDs from logical channel IDs based on the configuration by the IAB-donor. For RLC channels in downstream direction, the RLC channel ID may be included in the F1AP configuration of the RLC channel. For RLC channels in upstream direction, the RLC channel ID may be included in the RRC configuration of the corresponding logical channel. FIG. 13 shows an example of a functional view of BAP sublayer to which technical features of the present disclosure can be applied.

On the IAB-node, the BAP sublayer may contain one BAP entity at the MT function and a separate BAP entity at the DU function. On the IAB-donor DU, the BAP sublayer may contain only one BAP entity. Each BAP entity may have a transmitting part and a receiving part. The transmit part of the BAP entity may have a corresponding receiving part of a BAP entity at the IAB node or IAB donor DU across the backhaul link.

The receiving part on the BAP entity may deliver BAP PDUs to the collocated transmitting part on the BAP entity. Alternatively, the receiving part may deliver BAP SDUs to the collocated transmitting part. When passing BAP SDUs, the receiving part may remove the BAP header and the transmitting part may add the BAP header with the same BAP routing ID as carried on the BAP PDU header prior to removal. Passing BAP SDUs in this manner may be therefore functionally equivalent to passing BAP PDUs, in implementation.

The transmitting part of the BAP entity on the IAB-MT can receive BAP SDUs from upper layers and BAP Data Units from the receiving part of the BAP entity on the IAB-DU of the same IAB-node, and construct BAP Data PDUs as needed. The transmitting part of the BAP entity on the IAB-DU can receive BAP Data Units from the receiving part of the BAP entity on the IAB-MT of the same IAB node and construct BAP Data PDUs as needed. The transmitting part of the BAP entity on the IAB-donor DU can receive BAP SDUs from upper layers.

Upon receiving a BAP SDU from upper layers, the transmitting part of the BAP entity shall:
select a BAP address and a BAP path identity for this BAP SDU;
construct a BAP Data PDU by adding a BAP header to the BAP SDU, where the DESTINATION field is set to the selected BAP address and the PATH field is set to the selected BAP path identity.

When the BAP entity has a BAP Data PDU to transmit, the transmitting part of the BAP entity shall:
perform routing to determine the egress link;
determine the egress BH RLC channel;
submit this BAP Data PDU to the selected egress BH RLC channel of the selected egress link.

Data buffering on the transmitting part of the BAP entity. e.g., until RLC-AM entity has received an acknowledgement, may be performed. In case of BH RLF, the transmitting part of BAP entity may reroute the BAP Data PDUs, which has not been acknowledged by lower layer before the backhaul RLF, to an alternative path.

Upon receiving a BAP Data PDU from lower layer (i.e. ingress BH RLC channel), the receiving part of the BAP entity shall:
1> if DESTINATION field of this BAP PDU matches the BAP address of this node:
2> remove the BAP header of this BAP PDU and deliver the BAP SDU to upper layers.
1> else:
2> deliver the BAP Data Unit to the transmitting part of the collocated BAP entity.

When a BAP PDU that contains reserved or invalid values or contains a BAP address which is not included in the configured BH routing information received, the BAP entity shall discard the received BAP PDU.

Meanwhile, if an IAB node detects a problem on a backhaul (BH), the IAB node may send a BAP control PDU to its child nodes to indicate the BH problem.

For example, if the IAB node that detects the BH problem is connected to multiple parents, the IAB node may perform local re-routing by changing the path (e.g., switching a routing path for one or more data flows) from one parent to another parent.

For example, even if the IAB node that detects the BH problem is connected to multiple parents, the IAB may not perform local re-routing.

For example, if the IAB node that detects the BH problem is connected to a single parent, the IAB node may not perform local re-routing.

If a child node of the IAB node receives the BAP control PDU, the child node may consider that the BH may have problem. However, the child node may not know if its parent node has already performed local re-routing or not upon the occurrence of the indicated event (e.g., BH problem). If both the child node and its parent node perform local re-routing, it may result in unnecessary routing changes because the child node may not need to trigger local re-routing. Such unnecessary routing changes may impact the overall transmission performance and result in a larger deviation from the original routing planning that is in general considered optimal.

In the present disclosure, an IAB node may indicate to its child node(s) whether the IAB node performs local re-routing (e.g., switching a routing path for one or more data flows from a parent node to another parent node). The IAB node may further indicate information relate to traffic/data flows that are locally routed.

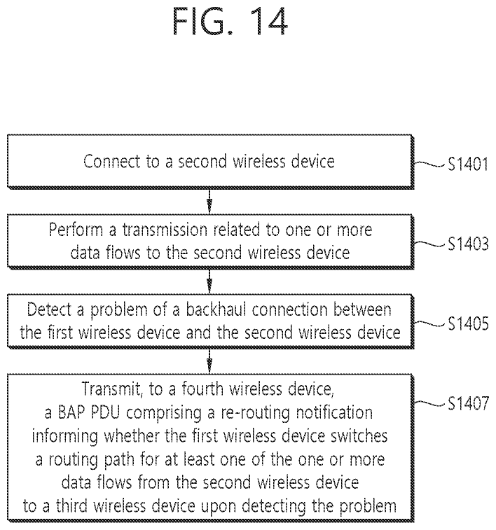

FIG. 14 shows an example of a method performed by fa node transmitting a re-routing notification according to an embodiment of the present disclosure. The node may comprise at least one of a wireless device (e.g., first wireless device in FIG. 14) or a UE.

Referring to FIG. 14, in step S1401, the first wireless device may connect to a second wireless device.

In step S1403, the first wireless device may perform a transmission related to one or more data flows to the second wireless device.

In step S1405, the first wireless device may detect a problem of a backhaul connection between the first wireless device and the second wireless device.

In step S1407, the first wireless device may transmit, to a fourth wireless device, a BAP PDU comprising a re-routing notification informing whether the first wireless device switches a routing path for at least one of the one or more data flows from the second wireless device to a third wireless device upon detecting the problem.

According to various embodiments, the second wireless device and the third wireless device may be a parent node for the first wireless device. The fourth wireless device may be a child node for the first wireless device.

According to various embodiments, the problem may comprise at least one of: an RLF on the backhaul connection, a transmission delay over the backhaul connection exceeding a threshold; an amount of queued packets over the backhaul connection exceeding a threshold; or a quality of the backhaul connection being lower than a threshold.

According to various embodiments, the BAP PDU may further comprise a backhaul problem notification informing that the problem of the backhaul connection is detected.

According to various embodiments, the one or more data flows may comprise one or more first data flows for which routing path is switched by the first wireless device and one or more second data flows for which routing path is not switched by the first wireless device. The re-routing notification may inform that the first wireless device switches a routing path for the one or more first data flows.

According to various embodiments, the re-routing notification may inform that the first wireless device does not switch a routing path for the one or more second data flows.

According to various embodiments, the first wireless device may transmit, to the fourth wireless device, flow information informing the one or more first data flows for which routing path is switched by the first wireless device.

According to various embodiments, the flow information may inform the one or more second data flows for which routing path is not switched by the first wireless device.

According to various embodiments, the flow information may be included in the BAP PDU.

According to various embodiments, the re-routing notification may comprise the flow information.

According to various embodiments, the node sending a BH RLF message may detect a BH RLF. The node may construct a BH RLF message indicating occurrence of BH RLF. The BH RLF message may include information indicating whether the node performs local re-routing. The node may transmit the BH RLF message to a child node.

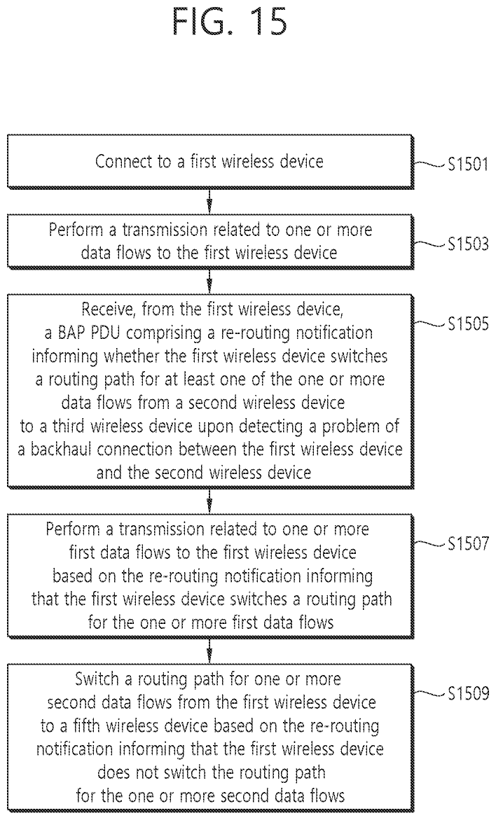

FIG. 15 shows an example of a method performed by a node receiving a re-routing notification according to an embodiment of the present disclosure. The node may comprise at least one of a wireless device (e.g., fourth wireless device in FIG. 15) or a UE.

Referring to FIG. 15, in step S1501, the fourth wireless device may connect to a first wireless device.

In step S1503, the fourth wireless device may perform a transmission related to one or more data flows to the first wireless device.

In step S1505, the fourth wireless device may receive, from the first wireless device, a BAP PDU comprising a re-routing notification informing whether the first wireless device switches a routing path for at least one of the one or more data flows from a second wireless device to a third wireless device upon detecting a problem of a backhaul connection between the first wireless device and the second wireless device.

In step S1507, the fourth wireless device may perform a transmission related to one or more first data flows to the first wireless device based on the re-routing notification informing that the first wireless device switches a routing path for the one or more first data flows.

In step S1509, the fourth wireless device may switch a routing path for one or more second data flows from the first wireless device to a fifth wireless device based on the re-routing notification informing that the first wireless device does not switch the routing path for the one or more second data flows.

According to various embodiments, the first wireless device and the fifth wireless device may be a parent node for the fourth wireless device. The second wireless device and the third wireless device may be a parent node for the first wireless device.

According to various embodiments, the BAP PDU may further comprise a backhaul problem notification informing that the problem of the backhaul connection is detected.

According to various embodiments, the fourth wireless device may transmit, to a child node for the fourth wireless device, a re-routing notification informing that a routing path for the one or more second data flows is not switched.

According to various embodiments, the fourth wireless device may transmit, to a child node for the fourth wireless device, a re-routing notification informing that a routing path for the one or more first data flows is switched.

According to various embodiments, the node receiving a BH RLF notification message may receive a BH RLF message indicating occurrence of BH RLF of a parent node. The BH RLF message may include information indicating whether the parent performs local re-routing. The node may determine whether to perform local re-routing based on the information. The node may perform local re-routing if the information indicates that the parent node does not perform local re-routing

More specifically, an IAB node, denoted by node A, may detect a BH RLF and/or BH problem on a BH towards a parent IAB node.

The node A may determine whether to perform local re-routing based on a condition (or, local re-routing condition) that is configured or pre-defined. The condition may comprise at least one of i) local re-routing is allowed, or ii) a problem of a backhaul connection towards the parent node is detected.

The node A may determine that local re-routing is allowed if the node A receives a particular type of BH RLF-related message.

For example, the node A may consider that local re-routing is allowed or needed if the node A receives a BH RLF message triggered upon failure of BH/BH RLF.

For example, the node A may consider that local re-routing is allowed or needed if the node A receives a BH RLF message triggered upon recovery from a failure of BH/BH RLF.

For example, the node A may consider that local re-routing is allowed or needed if the node A receives a BH RLF message triggered upon a recovery failure of BH/BH RLF (e.g., recovery of BH fails).

The node A may determine that local re-routing is allowed if the node A receives a particular type of BH PROBLEM-related message.

For example, the node A may consider that local re-routing is allowed or needed if the node A receives a BH PROBLEM message triggered upon failure of BH/BH PROBLEM.

For example, the node A may consider that local re-routing is allowed or needed if the node A receives a BH RLF message triggered upon a recovery from failure of BH/BH PROBLEM.

For example, the node A may consider that local re-routing is allowed or needed if the node A receives a BH PROBLEM message triggered upon a recovery failure of BH/BH PROBLEM (e.g., recovery of BH fails).

According to various embodiments, BH problem may be defined as:
an event that transmission delay over the backhaul exceeds a threshold;
an event that the amount of queued packets over the backhaul exceeds a threshold:
an event that the radio quality of the backhaul is lower than a threshold;
an event that the physical layer problem is detected based on e.g., a number of consecutive out-of-sync events detected on the backhaul connection reaching an RLF threshold during a pre-defined or configured time period; and/or
an event that an RLF is detected on a backhaul connection towards the parent node.

The node A may perform local re-routing of a subset of traffic/data flows that has been served by the node A

For example, the node A may be configured with traffic/data flows (or, BH RLC channels related to the traffic/data flows) for which local re-routing can be triggered. The node A may be configured with BH RLC channels for which local re-routing can be triggered. In this case, the node A may not be allowed to perform local re-routing for other BH RLC channel(s).

The node A may construct a BH RLF message indicating the occurrence of BH RLF. The node A may include information (i.e., re-routing notification) in the BH RLF message to indicate whether the node A performs local re-routing or not. The BH RLF message may be constructed as BAP control PDU.

For example, if the node A performs or decides to perform local re-routing, the node A may include information indicating that the node A performs local re-routing.

For example, if the node A does not perform or decides not to perform local re-routing, the node A may not include information indicating that the node A performs local re-routing or equivalently the node A may include information indicating that the node A does not perform local re-routing.

The information may further indicate information related to re-routing of partial traffic/data flows.

The node A may perform local re-routing for a subset of packets (or, traffic flows/data flows) that are traversed via the node A.

The node A may perform local re-routing for packets associated with a subset of configured BH RLC channels.

The node A may transmit the constructed BH RLF message to its child node(s) connected to the node A.

The node A may perform local re-routing if the node A determines to perform local re-routing, before the BH RLF message transmission.

The node A may transmit packets subject to re-routing (i.e., packets related to one or more data flows for which routing path is switched) to another parent node.

An IAB node, denoted by node B, may receive the BH RLF message from the node A.

The IAB node B may determine whether to perform local re-routing since the reception of the BH RLF message.

The node B may determine if the node sending the BH RLF message (i.e., node A) performs local re-routing, based on the information (i.e., re-routing notification) included in the BH RLF message.

For example, if the BH RLF message includes the information, the node B may not perform local re-routing even if the node B has another parent being connected.

For example, if the BH RLF message does not include the information, the node B may perform local re-routing if local re-routing is possible (i.e., the node B has another parent being connected) and needed (i.e., if local re-routing condition is satisfied).

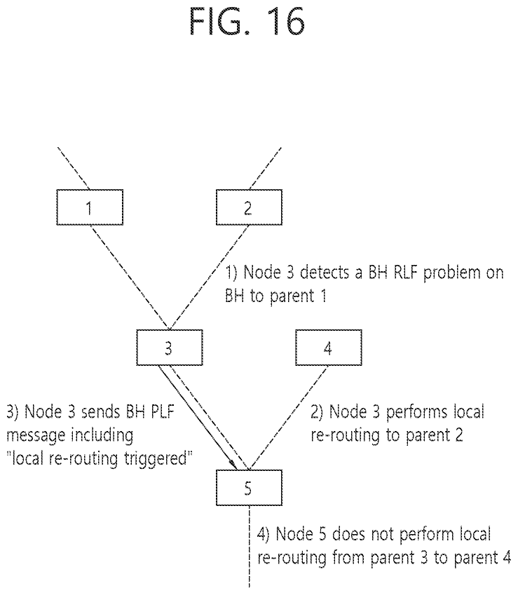

Hereinafter, scenarios related to re-routing notification are described with FIGS. 16 to 18. In FIGS. 16 to 18, node3 is connected to node 1 and node 2, and node5 is connected to node3 and 4. Node3 and node5 are capable of local re-routing by using their dual connection (i.e., connections established with two parent nodes in DC). A traffic flow that uses a route of traversing at least node5-node3-node1 may be regarded as upstream, and a traffic flow that uses a route of traversing at least node1-node3-node5 may be regarded as downstream.

FIG. 16 shows an example of a scenario in which re-routing notification is transmitted according to an embodiment of the present disclosure.

In FIG. 16:
1) Node3 may detect a problem on the BH between node3 and node1;
2) Node3 may determine to perform local re-routing because a local re-routing condition is satisfied upon the detection of BH problem. The node3 may transmit packets to node2 instead of node1 and receive packets from node2;
3) Node3 may send a BAP message indicating the BH problem to the child node. The BAP message may include information indicating “local re-routing triggered”; and
4) Node5 may receive the BAP message including information indicating “local re-routing triggered”. Node5 may decide not to perform local re-routing because node5 knows that node3 already performs local re-routing.

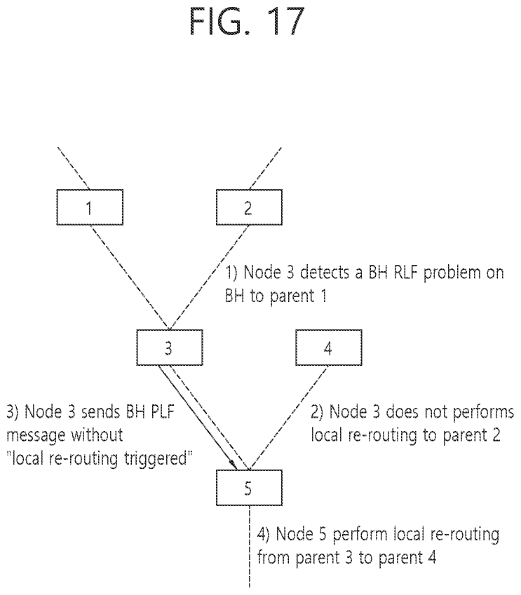

FIG. 17 shows an example of a scenario in which re-routing notification is not transmitted according to an embodiment of the present disclosure.

In FIG. 17:
1) Node3 may detect a problem on the BH between node3 and node1;
2) Node3 may determine not to perform local re-routing because a local re-routing condition is not satisfied upon the detection of BH problem. The node3 may keep using node1 as its parent;
3) Node3 may send a BAP message indicating the BH problem to the child node. The BAP message does not include information indicating “local re-routing triggered”; and
4) Node5 may receive the BAP message with no information indicating “local re-routing triggered”. Node5 may decide to perform local re-routing because node5 knows that node3 does not perform local re-routing.

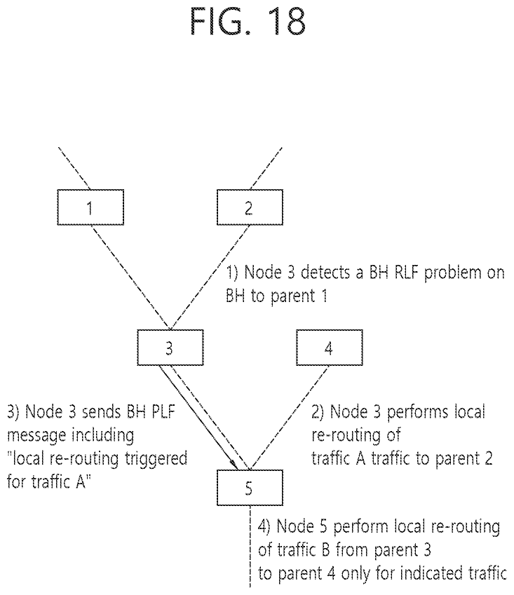

FIG. 18 shows an example of a scenario in which re-routing notification for specific traffic flow(s) is transmitted according to an embodiment of the present disclosure.

In this embodiment, the information included in the BH RLF message may comprise: which traffic flows/packets are locally re-routed by the node that transmits the BH RLF message; which traffic flows/packets are not locally re-routed by the node that transmits the BH RLF message; which traffic flows/packets can be locally re-routed by the node that receives the BH RLF message; and/or which traffic flows/packets cannot be locally re-routed by the node that receives the BH RLF message.

In FIG. 18:
1) Node3 serving traffic flow A and B may detect a problem on the BH between node3 and node1;
2) Node3 may determine to perform local re-routing for traffic A because a local re-routing condition is satisfied for traffic A upon the detection of BH problem. The node3 may keep using node1 as its parent for other traffic (e.g. traffic B);
3) Node3 may send a BAP message indicating the BH problem to the child node. The BAP message does not include information indicating “local re-routing triggered for traffic A”; and
4) Node5 may receive the BAP message with information indicating “local re-routing triggered for traffic A”. Node5 may decide to perform local re-routing for traffic B while maintaining its parent for traffic A.

Furthermore, the method in perspective of the first wireless device (i.e., node transmitting re-routing notification) described above in FIG. 14 may be performed by first wireless device 100 shown in FIG. 2, the wireless device 100 shown in FIG. 3, the first wireless device 100 shown in FIG. 4 and/or the UE 100 shown in FIG. 5.

More specifically, the first wireless device comprises at least one transceiver, at least processor, and at least one computer memory operably connectable to the at least one processor and storing instructions that, based on being executed by the at least one processor, perform operations.

The operations comprise: connecting to a second wireless device and a third wireless device in a dual connectivity (DC); performing a transmission related to one or more data flows to the second wireless device; detecting a problem of a backhaul connection between the first wireless device and the second wireless device; and transmitting, to a fourth wireless device, a backhaul adaptation protocol (BAP) protocol data unit (PDU) comprising a re-routing notification informing whether the first wireless device switches a routing path for at least one of the one or more data flows from the second wireless device to the third wireless device upon detecting the problem.

Furthermore, the method in perspective of the first wireless device described above in FIG. 14 may be performed by a software code 105 stored in the memory 104 included in the first wireless device 100 shown in FIG. 4.

More specifically, at least one computer readable medium (CRM) stores instructions that, based on being executed by at least one processor, perform operations comprising: connecting to a second wireless device and a third wireless device in a dual connectivity (DC); performing a transmission related to one or more data flows to the second wireless device; detecting a problem of a backhaul connection between the first wireless device and the second wireless device, and transmitting, to a fourth wireless device, a backhaul adaptation protocol (BAP) protocol data unit (PDU) comprising a re-routing notification informing whether the first wireless device switches a routing path for at least one of the one or more data flows from the second wireless device to the third wireless device upon detecting the problem.

Furthermore, the method in perspective of the first wireless device described above in FIG. 14 may be performed by control of the processor 102 included in the first wireless device 100 shown in FIG. 2, by control of the communication unit 110 and/or the control unit 120 included in the wireless device 100 shown in FIG. 3, by control of the processor 102 included in the first wireless device 100 shown in FIG. 4 and/or by control of the processor 102 included in the UE 100 shown in FIG. 5.

More specifically, an apparatus configured to operate in a wireless communication system (e.g., wireless device/UE) comprises at least processor, and at least one computer memory operably connectable to the at least one processor. The at least one processor is configured to perform operations comprising: connecting to a second wireless device and a third wireless device in a dual connectivity (DC); performing a transmission related to one or more data flows to the second wireless device; detecting a problem of a backhaul connection between the first wireless device and the second wireless device; and transmitting, to a fourth wireless device, a backhaul adaptation protocol (BAP) protocol data unit (PDU) comprising a re-routing notification informing whether the first wireless device switches a routing path for at least one of the one or more data flows from the second wireless device to the third wireless device upon detecting the problem.

Furthermore, the method in perspective of a fourth wireless device (i.e., node receiving re-routing notification) described above in FIG. 15 may be performed by second wireless device 100 shown in FIG. 2, the device 100 shown in FIG. 3, and/or the second wireless device 200 shown in FIG. 4.

More specifically, the fourth wireless device comprises at least one transceiver, at least processor, and at least one computer memory operably connectable to the at least one processor and storing instructions that, based on being executed by the at least one processor, perform operations.

The operations comprise: connecting to a first wireless device and a fifth wireless device in a dual connectivity (DC); performing a transmission related to one or more data flows to the first wireless device; receiving, from the first wireless device, a backhaul adaptation protocol (BAP) protocol data unit (PDU) comprising a re-routing notification informing whether the first wireless device switches a routing path for at least one of the one or more data flows from a second wireless device to a third wireless device upon detecting a problem of a backhaul connection between the first wireless device and the second wireless device; performing a transmission related to one or more first data flows to the first wireless device based on the re-routing notification informing that the first wireless device switches a routing path for the one or more first data flows; and switching a routing path for one or more second data flows from the first wireless device to the fifth wireless device based on the re-routing notification informing that the first wireless device does not switch the routing path for the one or more second data flows.

The present disclosure can have various advantageous effects.

For example, child node notified of a backhaul problem from a parent node can identify for which traffic flow the parent node has performed a local re-routing. Based on the notification, the child node can determine whether to perform a local re-routing, and determine for which traffic flow the child node had better perform a local re-routing. Therefore, unnecessary re-routing by the child node can be prevented.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method performed by a first wireless device in a wireless communication system, the method comprising:
connecting to a second wireless device;
performing a transmission related to one or more data flows to the second wireless device;
detecting a problem of a backhaul connection between the first wireless device and the second wireless device; and
transmitting, to a fourth wireless device, a backhaul adaptation protocol (BAP) protocol data unit (PDU) comprising a re-routing notification informing whether the first wireless device switches a routing path for at least one of the one or more data flows from the second wireless device to a third wireless device upon detecting the problem.

2. The method of claim 1, wherein the second wireless device and the third wireless device are a parent node for the first wireless device, and
wherein the fourth wireless device is a child node for the first wireless device.

3. The method of claim 1, wherein the problem comprises at least one of:
a radio link failure (RLF) on the backhaul connection;
a transmission delay over the backhaul connection exceeding a threshold;
an amount of queued packets over the backhaul connection exceeding a threshold; or
a quality of the backhaul connection being lower than a threshold.

4. The method of claim 1, wherein the BAP PDU further comprises a backhaul problem notification informing that the problem of the backhaul connection is detected.

5. The method of claim 1, wherein the one or more data flows comprise one or more first data flows for which routing path is switched by the first wireless device and one or more second data flows for which routing path is not switched by the first wireless device, and
wherein the re-routing notification informs that the first wireless device switches a routing path for the one or more first data flows.

6. The method of claim 5, wherein the re-routing notification informs that the first wireless device does not switch a routing path for the one or more second data flows.

7. The method of claim 5, further comprising:
transmitting, to the fourth wireless device, flow information informing the one or more first data flows for which routing path is switched by the first wireless device.

8. The method of claim 7, wherein the flow information informs the one or more second data flows for which routing path is not switched by the first wireless device.

9. The method of claim 7, wherein the flow information is included in the BAP PDU.

10. The method of claim 7, wherein the re-routing notification comprises the flow information.

11. The method of claim 1, wherein the first wireless device is in communication with at least one of a user equipment (UE), a mobile device, a network or autonomous vehicles.

12. A method performed by a fourth wireless device in a wireless communication system, the method comprising:
connecting to a first wireless device;
performing a transmission related to one or more data flows to the first wireless device;
receiving, from the first wireless device, a backhaul adaptation protocol (BAP) protocol data unit (PDU) comprising a re-routing notification informing whether the first wireless device switches a routing path for at least one of the one or more data flows from a second wireless device to a third wireless device upon detecting a problem of a backhaul connection between the first wireless device and the second wireless device;
performing a transmission related to one or more first data flows to the first wireless device based on the re-routing notification informing that the first wireless device switches a routing path for the one or more first data flows; and
switching a routing path for one or more second data flows from the first wireless device to a fifth wireless device based on the re-routing notification informing that the first wireless device does not switch the routing path for the one or more second data flows.

13. The method of claim 12, wherein the first wireless device and the fifth wireless device are a parent node for the fourth wireless device, and
wherein the second wireless device and the third wireless device are a parent node for the first wireless device.

14. The method of claim 12, wherein the BAP PDU further comprises a backhaul problem notification informing that the problem of the backhaul connection is detected.

15. The method of claim 12, further comprising:
transmitting, to a child node for the fourth wireless device, a re-routing notification informing that the routing path for the one or more second data flows is not switched.

16. The method of claim 12, further comprising:
transmitting, to a child node for the fourth wireless device, a re-routing notification informing that a routing path for the one or more first data flows switched.

17-20. (canceled)
